(19) United States
(12) Patent Application Publication
(10) Pub. No.: US 2019/0392102 A1
(43) Pub. Date: Dec. 26, 2019

(54) UNIFIED GEOMETRIES FOR DYNAMIC HIGH-PERFORMANCE COMPUTING

(71) Applicant: Xplicit Computing, Inc., Mountain View, CA (US)

(72) Inventor: Graham Jaffe Orr, Mountain View, CA (US)

(21) Appl. No.: 16/449,274

(22) Filed: Jun. 21, 2019

Related U.S. Application Data
(60) Provisional application No. 62/688,583, filed on Jun. 22, 2018.
(60) Provisional application No. 62/698,822, filed on Jul. 16, 2018.

(51) Int. Cl. G06F 17/50

(52) U.S. Cl. CPC G06F 17/5027; G06F 2217/14; G06F 2217/78; G06F 17/5086

(57) ABSTRACT

A simulation system receives a request to perform a function for a model having a specified geometry. The function is received as an interface that is not geometry specific. The simulation system determines the type of geometry of the model. If the simulation system determines that the geometry of the model is structured, a simulation engine of the simulation system executes a structured geometry specific implementation of the function. The structured geometry specific implementation of the function procedurally determines simulation data associated with the model. If the simulation system determines that the geometry of the model is not structured, or if the simulation system determines that the geometry of the model is unstructured, the simulation engine of the simulation system executes an unstructured geometry specific implementation of the function. The unstructured geometry specific function access a memory of a computing device for obtaining the simulation data associated with the model.

### CROSS REFERENCE TO RELATED APPLICATIONS

This application claims the benefit of U.S. Provisional Application No. 62/688,583, filed Jun. 22, 2018, and U.S. Provisional Application No. 62/698,822, filed Jul. 16, 2018, which are incorporated by reference in their entirety.

### BACKGROUND

This disclosure relates generally to computer simulations and physical modeling, and more specifically to simulation of models having different geometry types.

Different simulation schemes use different geometry types to model physical phenomena using finite mathematical methods. Engineers building simulations provide code to the simulation system to instruct the simulation system how to perform the simulations for different studies and configurations. Because data is formatted differently for varying geometry types, the code provided by the engineers is specific to a particular geometry type (mesh, grid, etc.). As a result, the code provided to the simulation system is often not reusable and a large proportion of time is spent building new the code for each type of geometry or interaction the engineer wishes to investigate or optimize. In some instances, an engineer would like to try different types of geometries for the same simulation to identify which configuration works best. In this scenario, the engineer would have to spend time and resources adapting or rewriting the code for each type of geometry being explored.

### SUMMARY

A simulation system receives a request to execute an algorithm upon a computer model having a specified geometry. The function is received at an interface that is not geometry specific, but rather provides several functions common and accessible across all types. The simulation system determines the type of geometry of the model, redirecting the interface functions to type-specific implementations. For instance, the simulation system determines whether the geometry of the model is a structured model. If the simulation system determines that the geometry of the model is structured, a simulation engine of the simulation system executes a structured geometry specific implementation of the function, utilizing alternate internal machinery to achieve a similar result. The structured geometry specific implementation of the function procedurally determines simulation data associated with the model. In some embodiments, the structured geometry specific implementation of the function determines the simulation data based on parameters of the structured geometry and an internal encoding scheme.

If the simulation system determines that the geometry of the model is not structured, or if the simulation system determines that the geometry of the model is unstructured, the simulation engine of the simulation system executes an unstructured geometry specific implementation of the function. The unstructured geometry specific function access a memory of a computing device for obtaining the simulation data associated with the model.

In some embodiments, the simulation system identifies a decision tree for the function. The leaves of the decision tree correspond to different implementations of the function for different types of geometries. The simulation system traverses the decision tree to identify the implementation of the function to execute based on characteristics of the model. For instance, the simulation system selects branches of the decision tree based on whether the specified geometry of the model is structured or unstructured.

### BRIEF DESCRIPTION OF THE DRAWINGS

FIG. 1 illustrates an overview of a simulation system, according to one embodiment.

FIG. 2 illustrates a tree diagram of the various specialized geometries, according to one embodiment.

FIG. 3 is an example of an inter-domain mutual coupling between disparate geometry types, according to one embodiment.

FIG. 4A illustrates a block diagram of the non-geometry-specific code, according to one embodiment.

FIG. 4B illustrates a block diagram of the unstructured geometry specific code, according to one embodiment.

FIG. 4C illustrates a block diagram of the structured geometry specific code, according to one embodiment.

FIG. 5A illustrates a flow diagram of a method for executing specialized code in the simulation of a model, according to one embodiment.

FIG. 5B illustrates a flow diagram of a method for executing specialized code in the simulation of a model, according to another embodiment.

FIG. 6 illustrates a flow diagram of a method for accessing data, according to one embodiment.

FIG. 7 illustrates a flow diagram for performing a spatial algorithm, according to one embodiment.

FIG. 8 illustrates a block diagram illustrating components of an example machine able to read instructions from a machine-readable medium and execute them in a processor (or controller).

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### Overview

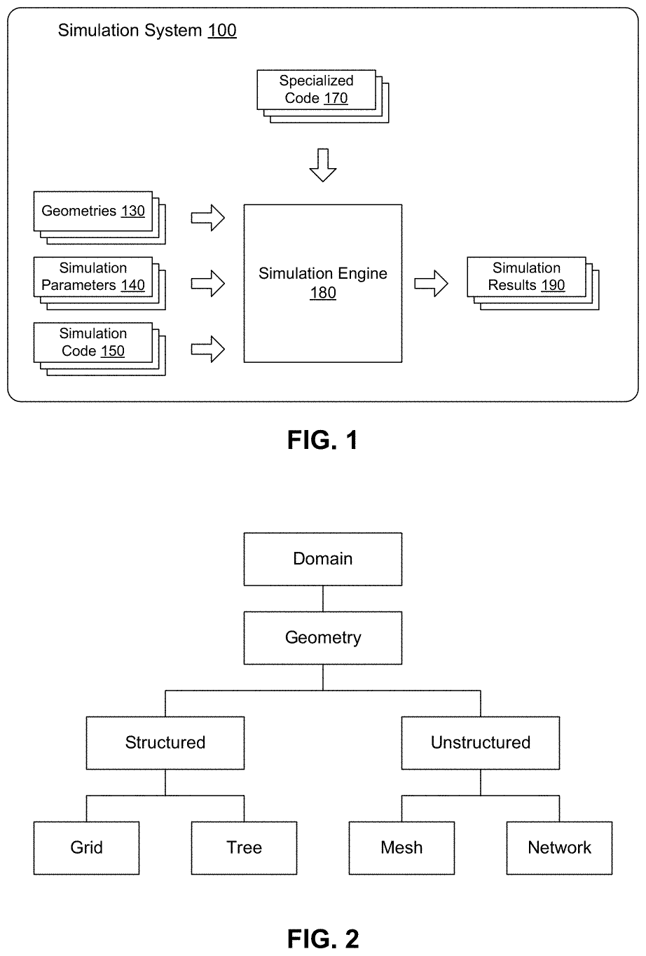

FIG. 1 illustrates an overview of a simulation system 100, according to one embodiment. A simulation engine 180 performs a simulation of a system based on a geometry 130, simulations parameters 140, and a simulation code 150. For instance, the geometry 130 defines a set of nodes in the simulated system, and the simulation code 150 defines a set of numerical algorithms (such as transport processes and state equations) to be solved for every node in the geometry 130. The simulation code 150 may further specify a parameter sweep (e.g., a time sweep or a temperature sweep) to be performed by the simulation engine.

The simulation parameters 140 are used to configure the simulation engine 180. For example, the simulation parameters 140 may specify a default numerical solver to be used by the physical models defined by the simulation code 150. The simulation parameters 140 may further specify a convergence condition (e.g., an acceptable margin of error) and a number of iterations before the simulation timeouts.

The simulation code 150 is geometry agnostic or compatible across multiple types. That is, the simulation code 150 is not specific to any geometry type. Instead, the simulation engine identifies a geometry specific implementation of the functions included in the simulation code 150 on the fly and redirects the interface functions to the specialized implementations for execution.

The simulation engine 180 uses a set of specialized codes 170 to execute the simulation code 150. The specialized code 170 includes code that is specific to geometry type. For example, specialized code 170 includes code that is specific to structured geometry types, and includes code that is specific to unstructured geometry types to provide access to specialized functions otherwise irrelevant to other types. This results in type-specific algorithms to operate only on a kind of geometry, in addition to type-agnostic algorithms compatible through the common interface. In some embodiments, within the code specific for structured geometry types, the specialized code 170 may include code for grid geometries and code for tree geometries. Moreover, within the code specific for unstructured geometry types, the specialized code 170 may include code for mesh geometries and network geometries.

In some embodiments, the simulation system may be an application specific integrated circuit (ASIC) or field programmable gate array (FPGA). In this embodiment, the specialized code 170 is implemented as specialized circuitry that implements the functionality for executing generic instructions provided by the simulation code 150. Additionally, each geometry instance can generate equivalent kernel source code for external co-processor device and set kernel arguments on the device prior to execution. The simulation system can then read device buffers and update the master data on the host system. This functionality allows the simulation system to utilize heterogeneous resources while allowing the use of the geometry agnostic interface using static and/or dynamic compilation and function dispatching.

As a first example of geometry specialization, consider a function that returns the position of a node in a specific geometry: Unstructured meshes read previously-written memory for the coordinate, whereas structured grids calculate values at runtime using a constant-time lookup (mitigating cache-misses and page-faults). Varied underlying machinery access geometries using the same function signature, redirecting runtime behavior while providing unified access patterns. This simplifies algorithm coding and exposes deep optimizations.

The disclosed system allows for the reusability of the simulation code for models using different types of geometries. Since the simulation code is geometry agnostic, a user of the simulation system may change the geometry 130 of the model used in the simulation without changing the simulation code 150. Moreover, since the simulation code 150 is geometry agnostic, the simulation engine 180 can execute an optimized implementation of the function to remove unneeded operations, interconnect bandwidth, or inefficient memory usage that would have been allocated if the model was modeled using a different geometry. For example, if the model uses a structured geometry, the simulation engine does not have to allocate memory and store data that can be determined procedurally. The simulation engine would determine whether to allocate memory to store simulation data based on the geometry type of the model. Engineers can take advantage of type optimization to run an order magnitude faster and/or bigger, but can also fall back on conventional and compatible types such as mesh when required.

FIG. 2 illustrates a tree diagram of the various specialized geometries, according to one embodiment. Domain is a concrete virtual base class that provides functionalities for non-geometry-specific functions like: checking whether one domain intersects another or ray cast through space. Spatial functions like position containment and delta between extrema also find are less specialized but find wide application (spanning server and client applications).

Geometry derives from domain, though itself is an abstract base containing both pure virtual and function overrides. Geometric topology, scalar data, and construction introduces new utilities such as region creation, and interfaces for element access and value sampling. Further specialization in procedural and declarative branches uncover major differences in function management: Structured leaves almost all functions to be defined later in derived types. Unstructured populates its table with overrides that are utilized by derived types. Build functions for grid, tree, network, and mesh types have unique and highly-specialized implementations.

Grid and tree derive from structured, and implement the functionality defined in the base geometry interface. The structured functions procedurally determine data elements based on predefined formulas. Mesh and network derive from unstructured. The unstructured functions access the data elements from memory. For instance, meshes and networks may store the data elements in arrays or other data structures that are stored in memory. The unstructured functions may define where in memory each type of data element is stored. In some embodiments, the unstructured functions define how to construct and return an element from other types of data stored in memory.

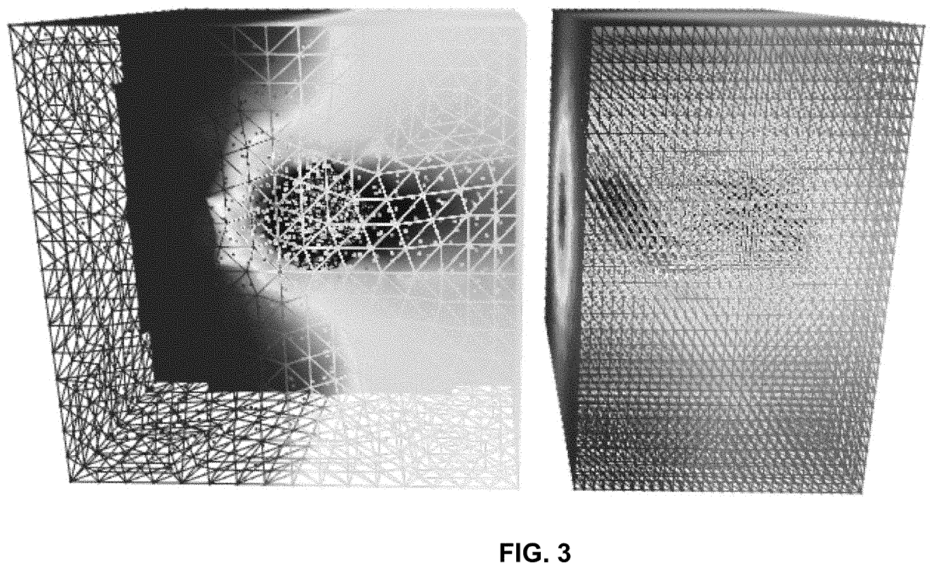

FIG. 3 is an example of an inter-domain mutual coupling between disparate geometry types, according to one embodiment. The example of FIG. 3 shows an unstructured mesh on the left and a structured grid on the right, running two independent numerical methods coupled in time and space. The example simulation shown includes a cylinder placed inside a viscid gas flow, with wake visible through domains.

In addition to allowing for code reusability, the disclosed system allows for improved interoperability of mismatched geometry types. In applications where more than one domain is simulated, higher-level interactions emerge when coupling across domains. Historically, there has been little standardization of spatial access patterns across types, so without the disclosed approach, high-performance interpolation across domains proves nearly-impossible for the vast majority of real-world numerical analysis problems. Most existing approaches are ad-hoc and case-specific as spatial machinery is uncommon between types. Domains may have independent physical models, desired discretization strategies, and numerical methods optimized for each domain (such as a fluid-structure interaction problem). It is numerically impractical and inefficient to attempt to homogenize such domains (usually leading to a non-optimized unstructured mesh as the lowest-common denominator). Furthermore, a single large simulation domain exacerbates compute device memory limitations, which are remedied by decomposing problems into multiple specialized domains. Therefore, a solution is sought to preserve runtime optimizations of each domain while enabling unified access patterns so that a robust generic interpolation algorithm can be implemented. Consider the following: If domains are the same type (e.g. mesh with mesh), one could use type-specific functions to perform interpolations and couple. If the domains are dissimilar (e.g. mesh with grid), either one must implement all permutations of type interactions or a generic common interface must be defined to facilitate communication between arbitrary geometry types with a single algorithm.

### System Architecture

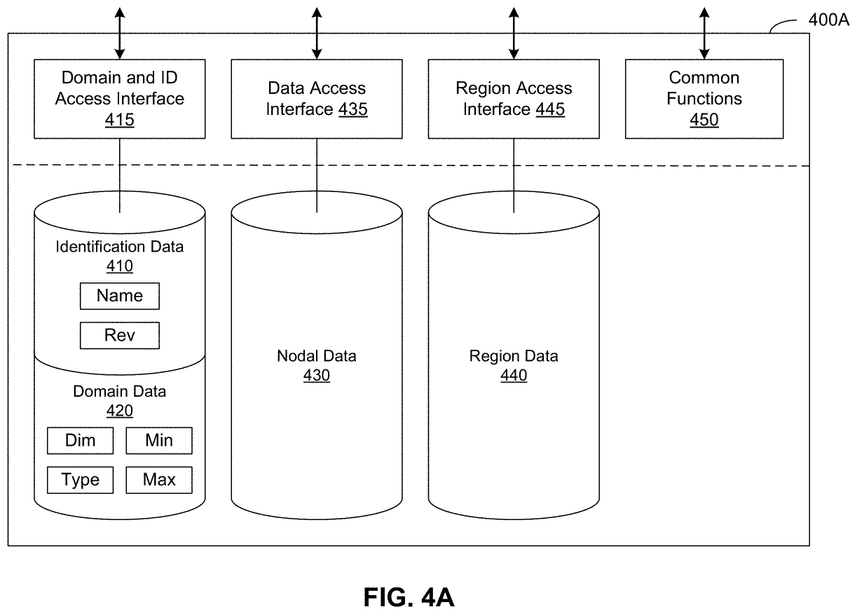

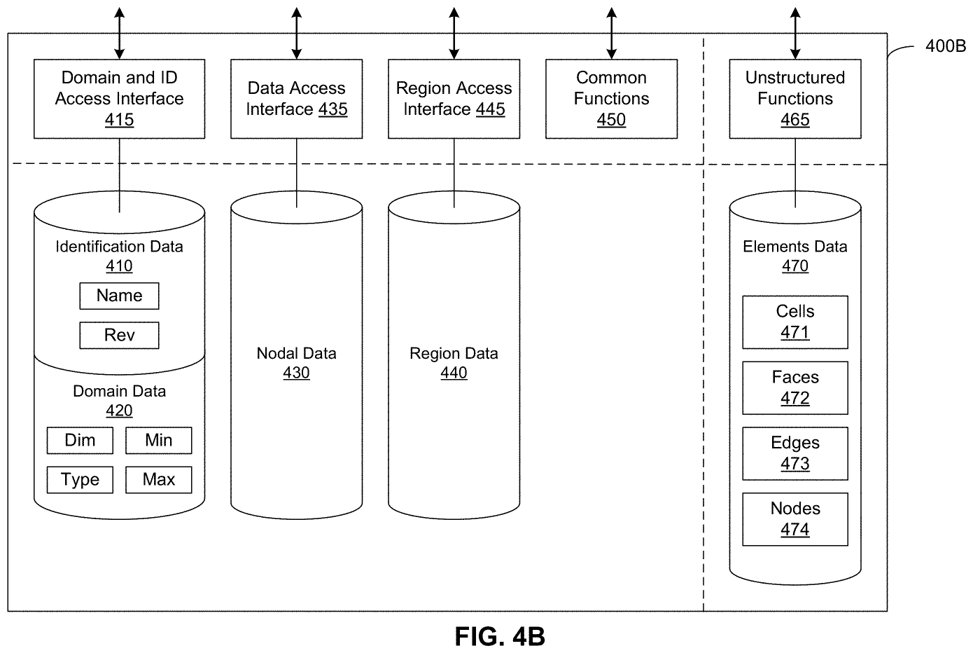

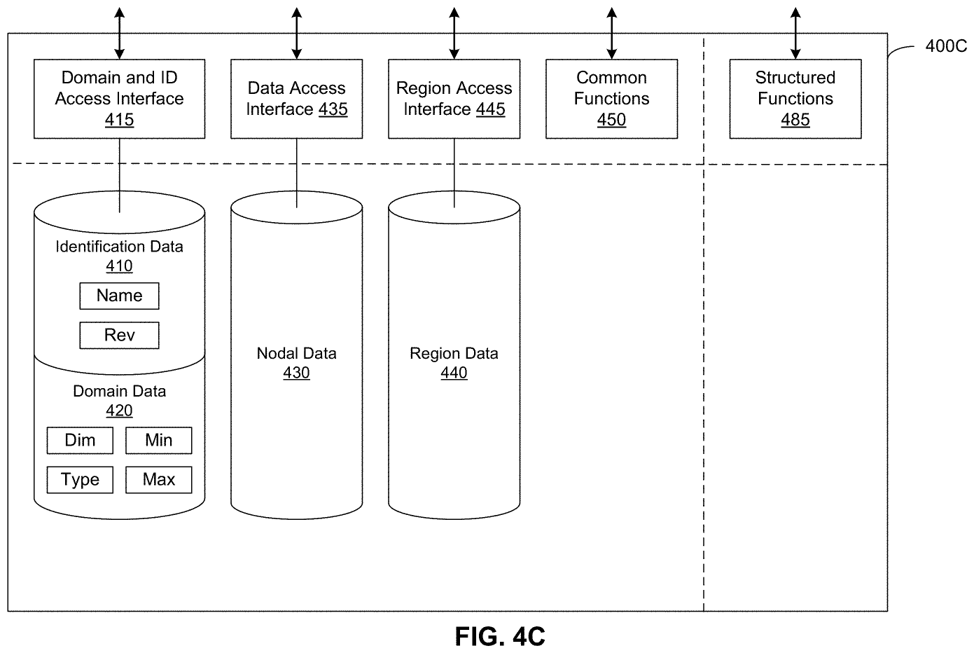

FIG. 4A illustrates a block diagram of the non-geometry-specific code, according to one embodiment. The non-geometry-specific code 400A includes code and an interface for geometry specific code to derive from. The non-geometry-specific code allows users to develop non-geometry-specific algorithms that can subsequently be applied and adapted to different types of geometries.

Each geometry type may have optimal differentiation and integration strategies creating overlapping compatibility families to facilitate inter-domain processes and fall-back (or redundant) algorithms. For instance, many numerical methods involve evaluation of a gradient, yet there are many ways to achieve this depending on the application. If a continuum is assumed in the domain, then sampling can apply Reynolds transport and divergence theorem to yield a robust solution. In grids and meshes, generic operators such as Green-Gauss Gradient can be the backbone of ubiquitous finite difference and viscid layer computations. Yet, where there is no topological divergence (orthonormal) this generality comes at some unnecessary numerical cost. Assumptions per application dictate the appropriateness of an algorithm (verb) bound to a geometry or other argument (noun).

The non-geometry-specific code 400A includes identification data 410 such as an instance name and revision number. Moreover, the non-geometry-specific code 400A includes domain data 420 such as dimension information, type information, minimum and maximum information. The identification data 410 and the domain data 420 is accessed through the domain and identification access interface 415. In addition, the non-geometry-specific code 400A includes nodal data 430, region data 440, and an interface for common functions 450.

The nodal data 430 provides a storage interface for per-node values, although it can also be applied on a per-element basis depending on the method. Nodal data often represents scalar field floating-point values at each node, organized by similar properties and optimized for concurrent access. For instance, nodal data could contain pressure and temperature values at all nodal points to be used for shape-optimization. Similarly, nodal data can store geometric-specific quantities of interest such as the Signed Distance Field (SDF) and curvature. Spatial methods can utilize this data with common or specialized functions such as value sampling for any property. The nodal data 430 is accessed using the data access interface 435. The data access interface includes functions such as functions for getting the nodal data, functions for synchronizing the nodal data, and functions for transforming the nodal data.

The region data 440 describes a container for topology subspaces spanning all useful dimensionalities, defining regions-of-interest for users and algorithms. Often, multiple regions are assigned, including Groups of Nodes (0d), open or closed Loops of Edges (1d), Surfaces of Faces, and/or Volumes of Cells. One embodiment of Regions is a convenient template meta-class for which the type can be bound at implementation. For example, in C++ we can declare:
Regions<Group> groups;
Regions<Loop> loops;
Regions<Surface> surfaces;
Regions<Volume> volumes.
   Group, Loop, Surface, and Volume each derive from Region which provides unified access pattern. As element data is ordered by region ID in its storage or procedural format, Regions do not require explicit storage of elements or references, but rather have an assigned element offset and element count for each region Id. This allows for lightweight subspace representation while maintaining compatibility with structured and unstructured geometries. The region data 440 is accessed using the region access interface 445. The region access interface includes functions for creating new regions, and for getting previously defined regions.

The interface for common functions 450 includes functions that are in common to all geometry types. For example, the common functions include functions for construction, determining or accessing a position, volume, sample, determining neighboring elements or adjacency. Each geometry type may have a different implementation for each of the functions. Since the non-geometry-specific code 400A includes an interface for accessing those functions, regardless of the geometry type, a user is able to generate code that uses the non-geometry-specific code interface for accessing the common functions 450. The simulation engine 180 is then capable of selecting the proper implementation based on the actual type of the geometry being used for a simulation.

The non-geometry-specific code 400A provides a unified interface that promotes high-level algorithm modularity and unlocks optimizations that provide a more than an order-magnitude benefit to analysis resolution and/or execution speed. Assumptions about the topology can reduce traffic and memory access—where possible functions that may have otherwise accessed memory calculate values “on the fly” given a set of encoded inputs. Such procedural approach yields major benefits but limits flexibility that is apparent in explicit declarative types.

FIG. 4B illustrates a block diagram of the unstructured geometry specific code, according to one embodiment. The unstructured geometry specific code derives from the non-geometry-specific code and implements functions that are specific to how data is stored for unstructured geometries. Unstructured geometries store in memory elements data 470, such as, information about cells 471, information about faces 472, information about edges 473, and information about nodes 474. The elements data 470 is accessed using unstructured geometry specific functions 465. Elements data includes the type of element and references to nodes describing the boundary of the element. For example, per-element attributes or functions may include position arrays for element centers and determination of the Domain bounding-box.

Elements define the base class for Nodes, Edges, Faces, and Cells, which inherit all attributes and functions while adding a few of their own specialized functions. For instance, surface area calculation is only relevant to surfaces, while total volume calculation can be performed at least two ways utilizing surfaces or volumes. Elements describe an efficient storage format for concurrent element access and maintain ordering by region ID. This ordering allows regions to simply look to a section of the element-space, rather than individual elements. In one embodiment, this is achieved using coalesced arrays for node indices, keeping track of the element stride (node count) and accumulated offsets, constructing the element data structure upon return. Other variations may pattern fixed-stride element templates in memory with similar offset-stride approach. Although specialized versions of Elements are convenient, they are not necessary for the function of this innovation but provide concrete implementations up to 3d:

Cells 471 are an embodiment of Elements of 3d dimensionality. Cells are accessed individually within a higher-level numerical process, returning a Cell containing an index array referencing adjacent nodes to describe the boundary vertexes of a primitive convex hull. Cells are stored in unstructured geometries, while they are generated procedurally in structured geometries limiting storage and transmission to encoded location codes, using specialized local decoding (construction) functions. Specialized per-cell attributes include a discrete volume calculation function. Common first-order cell types include 4-node tetrahedron (Tet4), 5-node pyramid (PyramidS), 6-node wedge (WedgeS), 8-node hexahedron (Hex8). Second-order Cell types may include 10-node tetrahedron (Tet10), 20-node hexahedron (Hex20), and so forth. Finite methods may utilize this Cell or its Voronoi inverse diagram for discrete calculations. One embodiment reconstructs an improved node-centric control volume by defining median dual-cell fragments centered around each node, as performed in Finite Volume method.

Faces 472 are an embodiment of Elements of 2d dimensionality. Faces are accessed individually within a higher-level numerical process, returning a Face containing an index array referencing adjacent nodes to describe the boundary vertexes of a primitive manifold. Faces are stored in unstructured geometries, while they are generated procedurally in structured geometries limiting storage and transmission to encoded location codes, using specialized local decoding (construction) functions. Specialized per-face attributes include a discrete area calculation function. Common first-order Face types include 3-node triangle (Tri3) and 4-node quadrilateral (Quad4). Second-order Face types may include 6-node triangle (Tri6), 8-node quadrilateral (Quad8), and so forth. Finite methods may utilize this Face or its Voronoi inverse diagram for discrete calculations.

Edges 473 are an embodiment of Elements of Id dimensionality. Edges are accessed individually within a higher-level numerical process, returning an Edge containing an index array referencing adjacent nodes to describe the boundary vertexes of a linear connection. Edges are stored in unstructured geometries, while they are generated procedurally in structured geometries limiting storage and transmission to encoded location codes, using specialized local decoding (construction) functions. Specialized per-edge attributes include a discrete distance calculation function. Common first-order edge types include 2-node line (Line2). Second-order Line types may include 3-node line (Line3), and so forth. Finite methods may utilize this Edge or its Voronoi inverse diagram for discrete calculations.

Nodes 474 are an embodiment of Elements of 0d dimensionality. Node are accessed individually within a higher-level numerical process, returning a Node containing an index array referencing itself or nothing. Nodes are stored in unstructured geometries, while they are generated procedurally in structured geometries limiting storage and transmission to encoded location codes, using specialized local decoding (construction) functions. Nodes describe spatial position using the base Element center calculation, so no further specialized functions are required.

The unstructured geometry specific code 170B includes unstructured functions that implement functionality for accessing the elements data 470. To provide the elements data 470, the unstructured functions implement functions that access the regions of memory that store the elements data and provides the accessed data. Moreover, the unstructured functions 465 implement functions for modifying the elements data 470 that is stored in memory.

The unstructured geometry may be a mesh topology or a network topology.

Meshes are defined by a closed cellular topology on manifolds \vec{x}∈R^{D}. Meshing fall into two categories: feature-based and stochastic. Feature-based solutions construct the domain by progressively-resolving regions from low-to-high fidelity. Control nodes are defined along parametric curves. Loops of edges and nodes are created along the curve between control nodes. Surface patches and corresponding faces, edges, and nodes are filled between loops. Volumes consisting of cells, faces, edges, and nodes are progressively resolved, providing high feature-control from feature-based representation. Large portions can be dominated by optimal element types (e.g. Hex8 in 3d), yet near complex interfaces, poor elements limit local CFL conditioning or matrix stiffness. This is quantified as a bimodal element quality distribution based on cell circumscribe or potential energy test around each node.

Stochastic mesh generation is based on Per-Olof Persson's thesis—yielding high-quality unimodal distributions to improve computability. A background geometry solves the Signed Distance Field (SDF) around the input reference surfaces to define an implicit shape function ϕ(\vec{x}) with reference surfaces at A. Negative values define interior and positive exterior:

∇·ϕ(\vec{x}) [symbol] and ϕ(A) [symbol] 0

Initial nodes are distributed across valid (positive or negative) SDF locations, followed by improvement taking an edge-wise spring-truss analogy. Displacement is constrained normal to boundaries, while nodes near SDF-defined surfaces iteratively project to progressively conform:

$$Δ \vec{x} = \frac{φ ( \vec{x} ) ∇ φ}{{\vert ∇ φ \vert}^{2}} + ϵ ( {O ( \vec{x} )}^{2} )$$

Upon completion, concave hulls and invalid elements are evaluated at quadrature points against the SDF and cleaned (with a surface unwrapping procedure) yielding naturally-fitting simplexes, to be later interpreted as median duals if desired. Enhancements to feature size and curvature refinement can be implemented by appending algorithms (that process upon SDF or other properties) to the meshing script. Stochastic equalization can be applied after feature-based mesh generation to yield more isotropic CFL characteristics by annealing neighbors k, forcing toward local radius goal rₒ:

∥\vec{x}−\vec{x}ₖ∥=rₒ(\vec{x})+∈(o(\vec{x})²)

Linear elements can achieve higher spatial accuracy by reconstructing and storing secondary element neighborhoods locally or using tree-like search spaces, though remain poorly-conditioned beyond second-order accuracy (due to proportional memory cost with diminishing returns). High-speed memory and interconnects remain relatively expensive, so mesh generation and resulting topology footprint keep unstructured meshes from dominating numerical analysis, especially where processes are resolved (instead of modeled). Galerkin approaches alleviate mesh limitations by constructing the solution as the sum of piecewise linearly-independent basis functions, demonstrating forward directions for unstructured domains.

Networks are distinguished by an open Markov-chain (graph-like) structure to constitute the most casual topology associativity, resulting in a degenerate topology ill-suited for continuum transport such as Finite Difference and Finite Volume methods. Network topologies can therefore have associativity ranging from zero to N\hat{ }2 and so it is up to the processing method to provide specific interpolation and associativity functions. A network can contain a mixture of elements, though most often nodes and edges are utilized by the processing format. Loose topology requirements allow Networks to take full advantage of dynamic shape definition, often utilizing a background geometry as utility integration field. For instance, with mesh generation, one could consider the initial geometry of a Network until it completes the meshing process, formally closing the topology into a Mesh. In other applications, Radial Basis Function (RBF) methods remove the need for topology altogether by superposing standard field functions around each Node, followed by field summations and differentiation on a background Grid. Pure Network interpolation schemes, including Galerkin methods, can provide accurate polynomial interpolations over Nodes. Highly dynamic processes such as impact and fracture mechanics can benefit from Network geometries, as well as Particle-In-Cell rarefied plasma simulations using a Network on a Grid background. Networks contain Nodes, sometimes utilize Edges, and rarely implement Faces or Cells.

FIG. 4C illustrates a block diagram of the structured geometry specific code, according to one embodiment. The structured geometry specific code derives from the non-geometry-specific code and implements functions that are specific to how data is determined for structured geometries. Unlike unstructured geometries where data is stored in memory, for structured geometries, the data can be procedurally derived using a set of consistent rules. For instance, the position of the nodes in a structured geometry can be determined by calling a function that defines the structured geometry. Topology information is not explicitly stored, as elements and attributes are computed deterministically from a set of analytic functions rather than member attributes defined in memory. Efficiency in memory and computation is a primary advantage, enabling increase in capacity by more than an order of magnitude due to alleviated interconnect traffic and processor cache faults. Benefits are realized in numerical methods that present a more physical interpretation, and less apparent in schemes that reconstruct associativity as required by the processing format (incurring larger solver memory penalties).

The structured geometry may be a grid topology or a tree topology, having no elements explicitly stored in memory.

Grids are the simplest spatial topology, characterized by periodic non-overlapping elements sufficiently-ordered to enable encoding of spatial position and element data using a multi-component integer location code found by folding indices against the Grid dimensions. Grids are particularly effective for quasi-isotropic process modeling where the phenomena is assumed to be statistically homogeneous a priori (such as turbulence or meshing). Grids also find use as background geometries to provide interpolation support on unstructured geometries.

Orthogonal basis transformations can project grids to other coordinate bases, including non-dimensional, cylindrical, and spherical isometries. Associativity remains untouched (with exception to degenerate boundaries) although accessors for position, face normal, and volume functions are transformed for local scaling and skewing. Tensor Q is locally-varying (per-node, defined in heterogeneous data) morphing to curves or field function:

\vec{x}′=Q\vec{x} where Q⁻¹=Q^{T}

Regular sampling presents an opportunity to incorporate digital signal processing techniques, such as convolution-based filters, well-suited to problems where spectral resolution and characterization are important.

Trees (such as quadtrees, or octrees) provide efficient encoding of volumetric data, yielding constant access time and dynamic refinement with lightweight underlying representation. The domain is divided in each dimension into locations that intrinsically preserve hierarchy information in an integer code, shifting load onto compute device (rather than memory or IO bottlenecks). Arithmetic properties of binary encoding allow direct bit-wise manipulation to resolve parent, child, and neighboring locations without memory access or relational tree traversal.

Trees are characterized by a recursive sub-dividing topology, resulting in nested overlapping elements that are sufficiently-ordered to allow for encoding of position and element data within a multi-component integer location code. If Grids have regular static topologies, Trees have recursive dynamic topologies. Tree generation can progress top-down or bottom-up to the desired level of detail, given input reference regions or elements. Trees only use memory and transmission of valid location codes and local nodal scalar data. Since a Tree bifurcates the domain progressively in powers of two for each dimension, location codes can take advantage of binary integer encoding. For instance, if a Cell is at binary location IJK and level L, its 2^{Dim} possible children can be at IJK+/−IJKroot/2^{L}, and so on down the tree. Element accessors and position functions perform bit-wise operations on the location codes to procedurally determine element neighbors and attributes. Value sampling is performed as the weighted sum of nodal values of containing cells, allowing for arbitrary-order interpolation. Such efficient and dynamic encoding makes Trees an attractive geometry for many methods and background geometries.

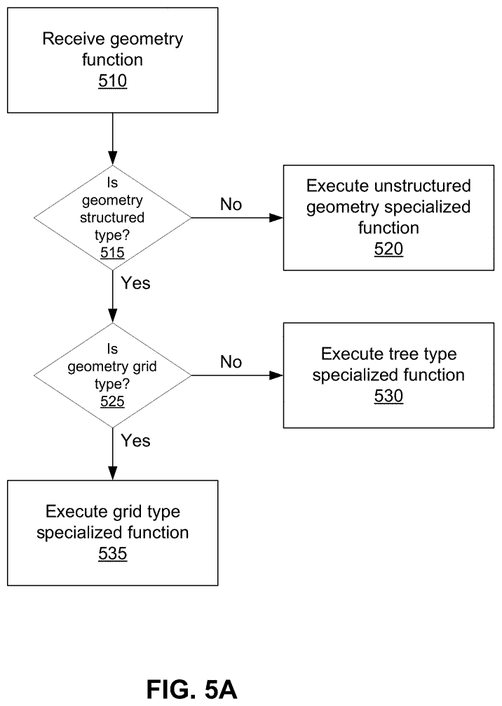

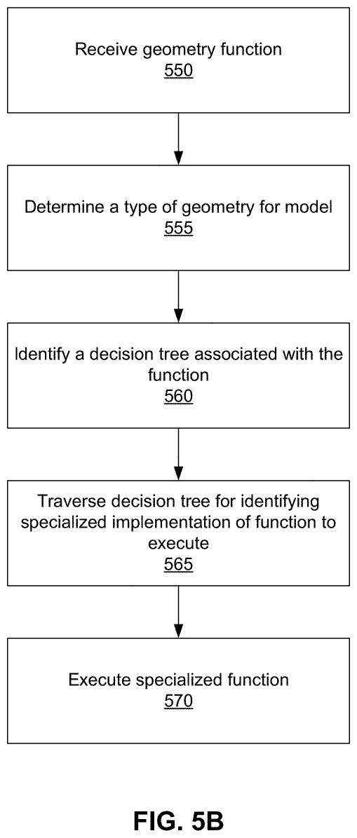

FIG. 5A illustrates a flow diagram of a method for executing specialized code in the simulation of a model, according to one embodiment. A geometry function is received 510. The geometry function received is a non-geometry-specific code interface that is defined in the based geometry interface. The geometry function is received as part of the simulation code 150. In addition, the geometry for which the function is to be applied is received.

A determination 515 is made whether the received geometry is of a structured type. If the geometry is not of a structured type, an unstructured geometry specialized implementation of the function is executed 520. In some embodiments, to execute the unstructured geometry specialized implementation of the function, the simulation code using the non-geometry-specific code interface is modified to replace the non-geometry-specific code interface with the unstructured geometry specialized code. In some embodiments, the unstructured geometry specialized implementation of the function access a memory of a computing system to obtain simulation data associated with the model.

In one embodiment, if the geometry is an unstructured geometry, a determination is made whether the geometry is a mesh. If the geometry is a mesh, a mesh specific implementation of the function is executed. For meshes, elements are explicitly described from a prior generative process (e.g., a mesh generator). Information used to explicitly define an element includes a type and references to nodes and index offsets to stripe write and read operations across memory. Element attributes of a mesh geometry may be calculated on-the-fly using explicitly-defined node references, or stored statically.

In another embodiment, if the geometry is an unstructured geometry, a determination is made whether the geometry is a network. If the geometry is a network, a network specific implementation of the function is executed. Networks oftentimes recast data in an external processing format that may utilize an associativity matrix or a background geometry to perform computations.

If the geometry is of a structured type, a determination 525 is made whether the structured geometry is of a grid type. If the geometry is not of a grid type, a tree type specialized implementation of the function is executed 530. Otherwise, if the geometry is of a grid type, a grid type specialized implementation of the function is executed 535. In some embodiments, the structured geometry implementations of the functions procedurally determine, based on parameters of the structured geometry, the simulation data associated with the model.

In one embodiment, if the geometry is a structured geometry, a determination is made whether the geometry is a grid. If the geometry is a grid, a grid specific implementation of the function is executed. Grids encode elements as an integer location code for each dimension. Node positions are functionally defined by ordered distribution of location codes across the grid domain bounds. The encoded location may be stored, transmitted, and decoded to resolve element attributes. Location code algorithms (e.g., arithmetical algorithms) determine neighboring topology, which may also decode to resolve neighboring elements. Grids reduce memory and interconnect bandwidth usage, enabling improvements in speed and resolution over unstructured geometries.

In another embodiment, if the geometry is a structured geometry, a determination is made whether the geometry is a tree. If the geometry is a tree, a tree specific implementation of the function is executed. Trees encode elements as an integer location code for each dimension. Nodes are defined as the corners of recursively sub-dividing cells that form a binary tree represented with binary encoding. Integer location codes utilize bit-wise operations to resolve parent, child, and neighbor location codes. Node positions are resolved by normalizing the location code by the largest integer and scaled by the tree domain bounds. The encoded location may be stored, transmitted, and decoded to resolve element attributes. Location code algorithms (e.g., arithmetical algorithms) determine neighboring topology, which may also decode to resolve neighboring elements. Trees reduce memory and interconnect bandwidth usage, enabling improvements in speed and resolution over unstructured geometries.

FIG. 5B illustrates a flow diagram of a method for executing specialized code in the simulation of a model, according to another embodiment. A geometry function is received 510. The geometry function received is a non-geometry-specific code interface that is defined in the based geometry interface. The geometry function is received as part of the simulation code 150. In addition, the geometry for which the function is to be applied is received.

A type of geometry is determined 555 for the model. The types of geometries may include grid, tree, mesh, network, and the like. In some embodiments, the system first determines whether the geometry of the model is structured or unstructured. The system the determines a sub-type. That is, if the system determines that the geometry is structured, the system then determines whether the geometry is a grid or a tree. Alternatively, if the system determines that the geometry is unstructured, the system then determines whether the geometry is a mesh or a network.

A decision tree associated with the received geometry function is identified 560. The leaves of the decision tree correspond to different implementations of the geometry function for different types of geometries. For example, the decision tree includes a leaf corresponding to the implementation of the function for grids, a leaf corresponding to the implementation of the function for trees, a leaf corresponding to the implementation of the function for meshes, and a leaf corresponding to the implementation of the function for networks. In some embodiments, the decision tree is a binary decision tree. In one embodiment, the decision tree is a balanced binary decision tree.

The decision tree is traversed 565 to identify an implementation of the function to execute. The decision tree is traversed by comparing certain characteristics of the model to decision steps in the decision tree. For instance, a decision step may specify to take a first branch if the geometry of the model is structured, and to take a second branch if the geometry of the model is unstructured. Moreover, for the structured branch, a decision step may specify to take one branch if the geometry is a grid, and to take another branch if the geometry is a tree. Furthermore, for the unstructured branch, a decision step may specify to take one branch if the geometry is a mesh, and to take another branch if the geometry is a network.

After identifying an implementation of the function by traversing the decision tree, the identified implementation of the function is executed 570.

In some embodiments, the geometry function may include a function for building the specific kind of geometry, a function for saving and loading with protocol buffers, a function for retrieving the number of elements of a given dimensionality from a geometry, a function for retrieving an element of a given dimensionality from a geometry, a function for identifying neighboring elements in the geometry, a function to sample a scalar or vector field with a test position, a function for generating kernel source code using string literal substitutions, and a function for setting kernel arguments prior to kernel execution on external device.

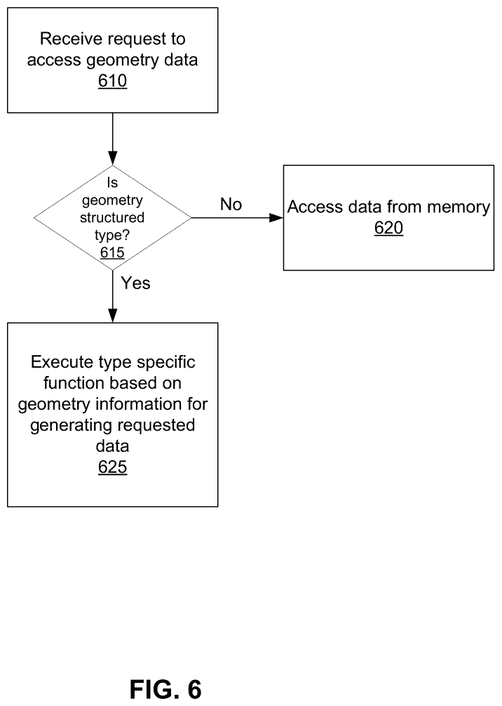

FIG. 6 illustrates a flow diagram of a method for accessing data, according to one embodiment. The simulation system 100 receives 610 a request to access data associated with a node of a geometry. A determination is made 615 whether the geometry is a structured type. If the geometry is not structured type, the data is accessed 620 from memory. Otherwise, if the geometry is a structured type, the data is generated by executing 625 a geometry specific function based on geometry information.

For example, to determine a number of nodes, if the geometry is of an unstructured type, the simulation system returns a size of the data structure (e.g., array) storing the nodes data. Otherwise, if the geometry is of a structured type, the simulation system calculates the number of nodes by multiplying the grid resolution in each of the dimensions of the geometry. That is, the simulation system may return the value:

$${\prod }_{d = 0}^{D - 1} grid \text{::} d$$

In a second example, to get an element of the geometry, if the geometry is of an unstructured type, the simulation system access and returns a cell stored in memory (e.g., contained in a data array stored in memory). Otherwise, if the geometry is of a grid type, the index of the requested element is folded into an ijk location, the neighbors of the element are identified, and the cell is procedurally constructed based on the domain dimensions and resolution.

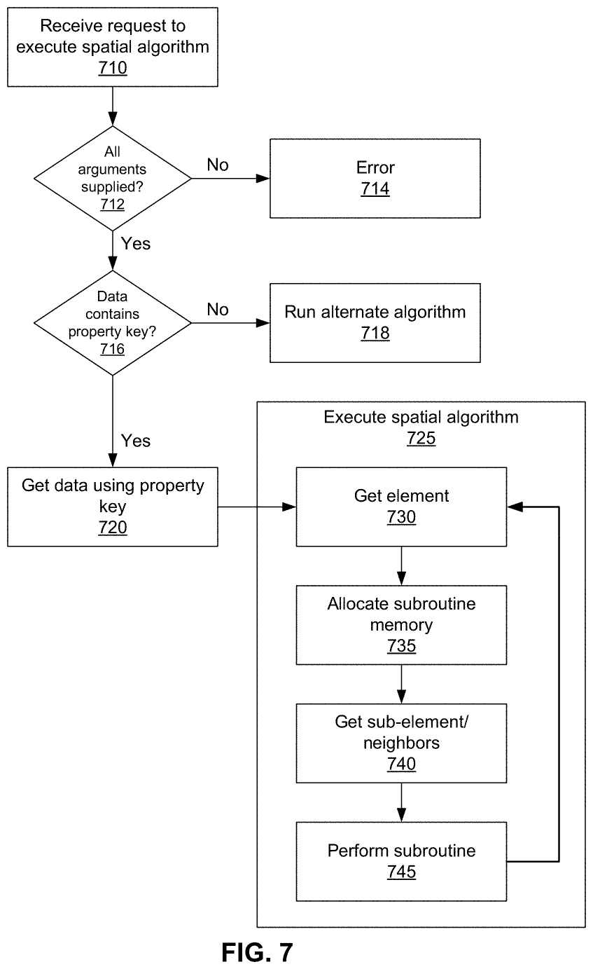

FIG. 7 illustrates a flow diagram for performing a spatial algorithm, according to one embodiment. A request to execute a spatial algorithm is received 710. A determination 712 whether all the arguments are provided for executing the spatial algorithm is made. If any argument is missing, an error is returned 714. Otherwise, a determination 716 is made whether the data contains a desired property key. A property key may be a unique identifier that is used to access a specific entry stored in nodal data. As an example, a property key could exist for mass, energy, pressure, temperature, temperature gradients, or any combination of “properties” and “modifiers.” If the data does not contain the desired property key, an alternate algorithm is run 718. In some embodiments, an error is returned instead. If the data contains the desired property key, the data is retrieved 720 using the property key.

The simulation system then for each element of the geometry, the spatial algorithm is executed 725. In some embodiments, the spatial algorithm for each element of the geometry is executed in parallel. To execute the spatial algorithm, an element of the geometry is retrieved 730. The element is retrieved in different ways depending on the type of the geometry. For instance, if the geometry is an unstructured type, the element is retrieved by accessing a memory. Alternatively, if the geometry is a structured type, the element is determined procedurally. The simulation system may determine how to get the element of the geometry by performing the steps shown in FIG. 5A or FIG. 5B.

If required, memory is allocated for the subroutine as a place to stage local thread results before assignment to the data vector.

A sub-element or a neighbor of the element is obtained 740. The sub-element or neighbors are retrieved in different ways depending on the type of geometry. That is, the simulation system selects a specialized code 170 based on a type of geometry being used.

The spatial subroutine is then executed 745 using the element, sub-elements, and/or neighboring elements retrieved. For example, the spatial subroutines include functions for determining a function for retrieving the number of elements of a given dimensionality from a geometry, a function for retrieving an element of a given dimensionality from a geometry, a function for identifying neighboring elements in the geometry, a function to sample a scalar or vector field from a test position. After the spatial subroutine is executed, the flow loops back to step 730 until every element has been processed.

The spatial algorithm may be provided to the simulation system 100 as a geometry agnostic simulation code. The simulation engine 180 can then identify the appropriate specialized code 170 to execute the geometry agnostic simulation code based on the geometry of the model provided to the simulation system together with the geometry agnostic simulation code. As such, a user of the simulation system 100 can execute the same geometry agnostic simulation code with different geometry configurations without having to modify the simulation code.

### Computing Machine Architecture

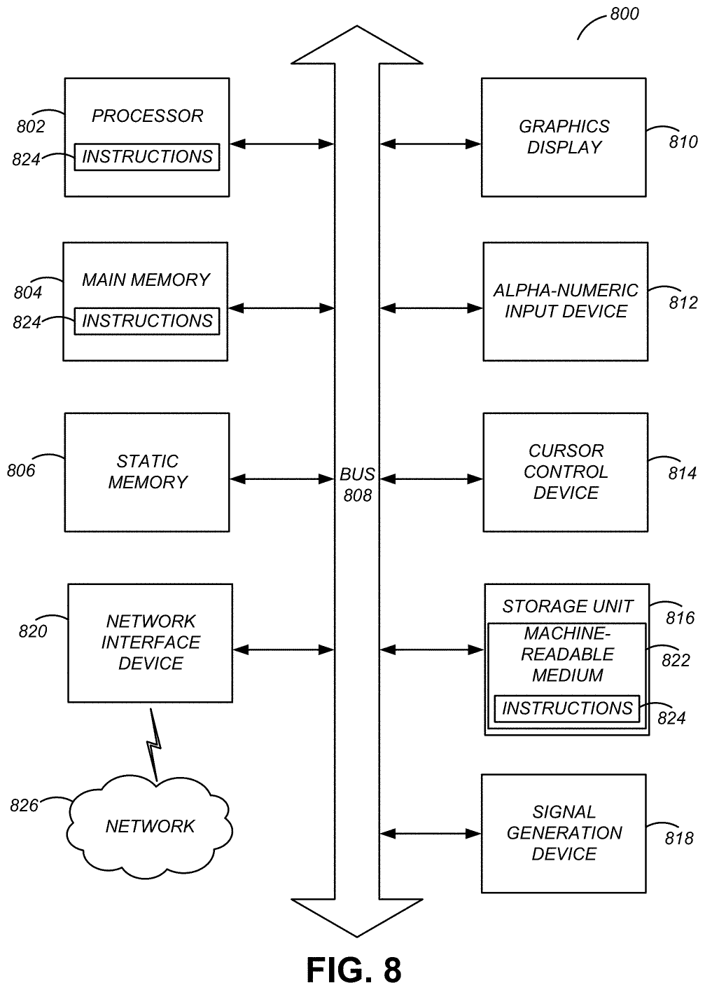

FIG. 8 is a block diagram illustrating components of an example machine able to read instructions from a machine-readable medium and execute them in a processor (or controller). Specifically, FIG. 8 shows a diagrammatic representation of a machine in the example form of a computer system 800 within which instructions 824 (e.g., software) for causing the machine to perform any one or more of the methodologies discussed herein may be executed. In alternative embodiments, the machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a personal digital assistant (PDA), a cellular telephone, a smartphone, a web appliance, a network router, switch or bridge, or any machine capable of executing instructions 824 (sequential or otherwise) that specify actions to be taken by that machine. Further, while only a single machine is illustrated, the term “machine” shall also be taken to include any collection of machines that individually or jointly execute instructions 824 to perform any one or more of the methodologies discussed herein.

The example computer system 800 includes a processor 802 (e.g., a central processing unit (CPU), a graphics processing unit (GPU), a digital signal processor (DSP), one or more application specific integrated circuits (ASICs), one or more radio-frequency integrated circuits (RFICs), or any combination of these), a main memory 804, and a static memory 806, which are configured to communicate with each other via a bus 808. The computer system 800 may further include graphics display unit 810 (e.g., a plasma display panel (PDP), a liquid crystal display (LCD), a projector, or a cathode ray tube (CRT)). The computer system 800 may also include alphanumeric input device 812 (e.g., a keyboard), a cursor control device 814 (e.g., a mouse, a trackball, a joystick, a motion sensor, or other pointing instrument), a storage unit 816, a signal generation device 818 (e.g., a speaker), and a network interface device 820, which also are configured to communicate via the bus 808.

The storage unit 816 includes a machine-readable medium 822 on which is stored instructions 824 (e.g., software) embodying any one or more of the methodologies or functions described herein. The instructions 824 (e.g., software) may also reside, completely or at least partially, within the main memory 804 or within the processor 802 (e.g., within a processor's cache memory) during execution thereof by the computer system 800, the main memory 804 and the processor 802 also constituting machine-readable media. The instructions 824 (e.g., software) may be transmitted or received over a network 826 via the network interface device 820.

While machine-readable medium 822 is shown in an example embodiment to be a single medium, the term “machine-readable medium” should be taken to include a single medium or multiple media (e.g., a centralized or distributed database, or associated caches and servers) able to store instructions (e.g., instructions 824). The term “machine-readable medium” shall also be taken to include any medium that is capable of storing instructions (e.g., instructions 824) for execution by the machine and that cause the machine to perform any one or more of the methodologies disclosed herein. The term “machine-readable medium” includes, but not be limited to, data repositories in the form of solid-state memories, optical media, and magnetic media.

### CONCLUSION

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of ordinary skill in the art will appreciate still additional alternative structural and functional designs through the disclosed principles of the embodiments. Thus, while particular embodiments and applications have been illustrated and described, it is to be understood that the embodiments are not limited to the precise construction and components disclosed herein and that various modifications, changes and variations which will be apparent to those skilled in the art may be made in the arrangement, operation and details of the method and apparatus disclosed herein without departing from the spirit and scope as defined in the appended claims.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A method comprising:
receiving a request to perform a function for a model having a specified geometry, the function received as an interface that is not geometry specific;
determining whether the geometry of the model is a structured geometry;
responsive to determining that the geometry of the model is a structured geometry, executing a structured geometry specific implementation of the function, the structured geometry specific implementation of the function procedurally determining, based on parameters of the structured geometry, simulation data associated with the model;
responsive to determining that the geometry of the model is not a structured geometry, executing an unstructured geometry specific function, the unstructured geometry specific function accessing a memory of a computing device for obtaining the simulation data associated with the model.

2. The method of claim 1, wherein executing the structured geometry specific implementation of the function comprises:
responsive to determining that the geometry is a structured geometry, determining whether the structured geometry is a grid; and
responsive to determining that the structured geometry is a grid, executing a grid specific implementation of the function.

3. The method of claim 1, wherein executing the structured geometry specific implementation of the function comprises:
responsive to determining that the geometry is a structured geometry, determining whether the structured geometry is a tree; and
responsive to determining that the structured geometry is a tree, executing a tree specific implementation of the function.

4. The method of claim 1, wherein executing the unstructured geometry specific implementation of the function comprises:
responsive to determining that the geometry is an unstructured geometry, determining whether the structured geometry is a mesh; and
responsive to determining that the unstructured geometry is a mesh, executing a mesh specific implementation of the function.

5. The method of claim 1, wherein executing the unstructured geometry specific implementation of the function comprises:
responsive to determining that the geometry is an unstructured geometry, determining whether the structured geometry is a network; and
responsive to determining that the unstructured geometry is a network, executing a network specific implementation of the function.

6. The method of claim 1, further comprising:
identifying a decision tree for the function, wherein the leaves of the decision tree correspond to different implementations of the function for different types of geometries;
traversing the decision tree to identify an implementation of the function to execute based on characteristics of the model; and
executing the identifying implementation of the function.

7. The method of claim 6, wherein traversing the decision tree comprises:
selecting a branch of the decision tree based on whether the specified geometry of the model is a structured geometry or an unstructured geometry.

8. The method of claim 1, wherein the function is one of a function for building the specified geometry, a function for saving or loading, a function for retrieving a number of elements of a given dimensionality from a geometry, a function for retrieving an element of a given dimensionality from a geometry, a function for identifying neighboring elements in the geometry, a function to sample a scalar or vector field from a test position, a function for generating kernel source code using string literal substitutions, and a function for setting kernel arguments prior to execution.

9. A non-transitory computer-readable storage medium configured to store instructions, the instructions when executed by a processor cause the processor to:
receive a request to perform a function for a model having a specified geometry, the function received as an interface that is not geometry specific;
determine whether the geometry of the model is a structured geometry;
responsive to determining that the geometry of the model is a structured geometry, execute a structured geometry specific implementation of the function, the structured geometry specific implementation of the function procedurally determining, based on parameters of the structured geometry, simulation data associated with the model;
responsive to determining that the geometry of the model is not a structured geometry, execute an unstructured geometry specific function, the unstructured geometry specific function accessing a memory of a computing device for obtaining the simulation data associated with the model.

10. The non-transitory computer-readable storage medium of claim 9, wherein executing the structured geometry specific implementation of the function comprises:
responsive to determining that the geometry is a structured geometry, determining whether the structured geometry is a grid; and
responsive to determining that the structured geometry is a grid, executing a grid specific implementation of the function.

11. The non-transitory computer-readable storage medium of claim 9, wherein executing the structured geometry specific implementation of the function comprises:
responsive to determining that the geometry is a structured geometry, determining whether the structured geometry is a tree; and
responsive to determining that the structured geometry is a tree, executing a tree specific implementation of the function.

12. The non-transitory computer-readable storage medium of claim 9, wherein executing the unstructured geometry specific implementation of the function comprises:
responsive to determining that the geometry is an unstructured geometry, determining whether the structured geometry is a mesh; and
responsive to determining that the unstructured geometry is a mesh, executing a mesh specific implementation of the function.

13. The non-transitory computer-readable storage medium of claim 9, wherein executing the unstructured geometry specific implementation of the function comprises:
responsive to determining that the geometry is an unstructured geometry, determining whether the structured geometry is a network; and
responsive to determining that the unstructured geometry is a network, executing a network specific implementation of the function.

14. The non-transitory computer-readable storage medium of claim 9, wherein the instructions further cause the processor to:
identify a decision tree for the function, wherein the leaves of the decision tree correspond to different implementations of the function for different types of geometries;
traverse the decision tree to identify an implementation of the function to execute based on characteristics of the model; and
execute the identifying implementation of the function.

15. The non-transitory computer-readable storage medium of claim 14, wherein traversing the decision tree comprises:
selecting a branch of the decision tree based on whether the specified geometry of the model is a structured geometry or an unstructured geometry.

16. The non-transitory computer-readable storage medium of claim 9, wherein the function is one of a function for building the specified geometry, a function for saving or loading, a function for retrieving a number of elements of a given dimensionality from a geometry, a function for retrieving an element of a given dimensionality from a geometry, a function for identifying neighboring elements in the geometry, a function to sample a scalar or vector field from a test position, a function for generating kernel source code using string literal substitutions, and a function for setting kernel arguments prior to execution.

17. A system comprising:
a processor; and
a non-transitory computer-readable storage medium configured to store instructions, the instructions when executed by a processor cause the processor to:
receive a request to perform a function for a model having a specified geometry, the function received as an interface that is not geometry specific;
determine whether the geometry of the model is a structured geometry;
responsive to determining that the geometry of the model is a structured geometry, execute a structured geometry specific implementation of the function, the structured geometry specific implementation of the function procedurally determining, based on parameters of the structured geometry, simulation data associated with the model;
responsive to determining that the geometry of the model is not a structured geometry, execute an unstructured geometry specific function, the unstructured geometry specific function accessing a memory of a computing device for obtaining the simulation data associated with the model.

18. The system of claim 17, wherein executing the structured geometry specific implementation of the function comprises:
responsive to determining that the geometry is a structured geometry:
determining whether the structured geometry is a grid;
responsive to determining that the structured geometry is a grid, executing a grid specific implementation of the function;
determining whether the structured geometry is a tree; and
responsive to determining that the structured geometry is a tree, executing a tree specific implementation of the function.

19. The system of claim 17, wherein executing the unstructured geometry specific implementation of the function comprises:
responsive to determining that the geometry is an unstructured geometry:
determining whether the structured geometry is a mesh;
responsive to determining that the unstructured geometry is a mesh, executing a mesh specific implementation of the function;
determining whether the structured geometry is a network; and
responsive to determining that the unstructured geometry is a network, executing a network specific implementation of the function.

20. The system of claim 17, wherein the instructions further cause the processor to:
identify a decision tree for the function, wherein the leaves of the decision tree correspond to different implementations of the function for different types of geometries;
traverse the decision tree to identify an implementation of the function to execute based on characteristics of the model by selecting a branch of the decision tree based on whether the specified geometry of the model is a structured geometry or an unstructured geometry; and
execute the identifying implementation of the function.
